(19) United States
(12) Patent Application Publication
(10) Pub. No.: US 2013/0159059 A1
(43) Pub. Date: Jun. 20, 2013

(54) FREIGHT MARKET DEMAND MODELING AND PRICE OPTIMIZATION

(71) Applicant: Denis Malov, Scottsdale, AZ (US)

(72) Inventor: Denis Malov, Scottsdale, AZ (US)

(73) Assignee: SAP AG, Wallodrf (DE)

(21) Appl. No.: 13/331,538

(22) Filed: Dec. 20, 2011

(51) Int. Cl. G06Q 30/02

(52) U.S. Cl. 705/7.35

(57) ABSTRACT

Various embodiments herein include at least one of systems, methods, and software for freight market demand modeling and price optimization. Some such embodiments include acquiring historical data regarding hauled loads, bid loads that were not hauled, data representative of at least one of current and expected conditions, and data representing business goals. The acquired data may then be mapped to market segments and a statistical, spot load demand model is generated for each market segment based on a number of factors included in the mapped data including at least a load price factor. A demand and price forecast model may next be generated for each market segment based on the generated model and the data representative of at least one of current and expected conditions. For each market segment, a pricing element may then be determined based on the respective market segment model and forecast in view of the business goals.

### BACKGROUND INFORMATION

In the over-the-road trucking business, when shippers have unplanned or exception loads that are not covered by contracts with carriers, shippers reach out to the spot load market. A spot load market request can be performed directly (direct channel) by calling or messaging a customer representative of a carrier or by submitting a request through a broker (indirect channel). In addition, Internet-based toad boards are becoming popular with shippers due to their appeal of matching loads to the best-suited carrier. However, because toad and carrier availability and equipment capacity on the spot market are not set by contractual obligations, terms and pricing conditions for each transaction are subject to real-time pricing.

The spot load market is a very significant part of the transportation business. In the United States, the spot load market is estimated to be approximately $1 Billion annually, or 15% of the total over-the-road freight. Successful planning and execution of the spot load market requires systems capable of dynamic real-time operations. The United States trucking industry is extremely fragmented due to a very low cost of entry. There are over 10,000 carrier companies consisting of a single truck, and several carrier companies consisting of over 10,000 trucks. The overall United States trucking industry employs close to two million drivers and is facing severe qualified workforce shortages. These factors create a very competitive business environment with strong dependence on economic conditions. Further, carriers operate on very thin margins and have significant risk exposure to adverse economic conditions.

### BRIEF DESCRIPTION OF THE DRAWINGS

FIG. 1 is an illustration of a typical spot load market shipper/carrier interaction.

FIG. 2 is block diagram of a method according to an example embodiment.

FIG. 3 is block diagram of a method according to an example embodiment.

FIG. 4 is block diagram of a method according to an example embodiment.

FIG. 5 is a block diagram of a computing device, according to an example embodiment.

FIG. 6 is a block diagram of a computer program, according to an example embodiment.

### DETAILED DESCRIPTION

In the spot load segment of the over-the-road trucking business, quotes are typically provided and accepted or rejected over the telephone. Trucking company customer service representatives receive quote requests and information regarding the load such as cargo, origin and destination locations, time constraints, time and equipment needed to load and unload, and other information depending on the particular load. A customer service representative may then provide a pricing bid for the load such as rate per mile, fuel surcharge, total price, application insurance, and the like. The bid is typically arrived at manually by the customer service representative, a pricing analyst, or other employee of the trucking company based generally on current and historical information. However, the real-time, changing nature of factors affecting spot load prices make it challenging to consistently determine optimal or near optimal rates for any given time. The customer service representative, a pricing analyst, or other employee of the trucking company providing the spot load price quote are often made on a “gut feel” rather than measured business and market factors. As a result, profit is often limited and performance can be unpredictable.

Various embodiments illustrated and described herein include at least one of systems, methods, and software that model spot load demand and optimize spot load pricing in view of different factors, such as one or more of market conditions, business rules, key performance indicators, equipment locations, current and forecasted weather, seasonal weather trends, and other factors. Such embodiments facilitate trucking companies in setting strategic and tactical pricing decisions with predictable and measurable results, although in some embodiments the focus of pricing decisions is tactical, such as over a two to three-week period. Further, through application of business rules and taking into account market indicator data, increased risk exposures associated with certain loads can be mitigated or priced more in line with the exposure. Thus, through use of such embodiments, carriers are able to optimize spot load pricing to better meet current and evolving market conditions and align spot load pricing carrier strategies.

Generally, loads referred to in the various embodiments described herein are spot loads unless it is either explicit or contextually clear that the particular load being referred to is a load other than a spot toad.

In the following detailed description, reference is made to the accompanying drawings that form a part hereof, and in which is shown by way of illustration specific embodiments in which the inventive subject matter may be practiced. These embodiments are described in detail to enable those skilled in the art to practice them, and it is to be understood that other embodiments may be utilized and that structural, logical, and electrical changes may be made without departing from the scope of the inventive subject matter. Such embodiments of the subject matter herein may be referred to, individually and/or collectively, herein by the term “invention” merely for convenience and without intending to voluntarily limit the scope of this application to any single invention or inventive concept if more than one is in fact disclosed. The following description is, therefore, not to be taken in a limited sense, and the scope of the inventive subject matter is defined by the appended claims.

The functions or algorithms described herein are implemented in hardware, software, or a combination of software and hardware in one embodiment. The software comprises computer executable instructions stored on tangible computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

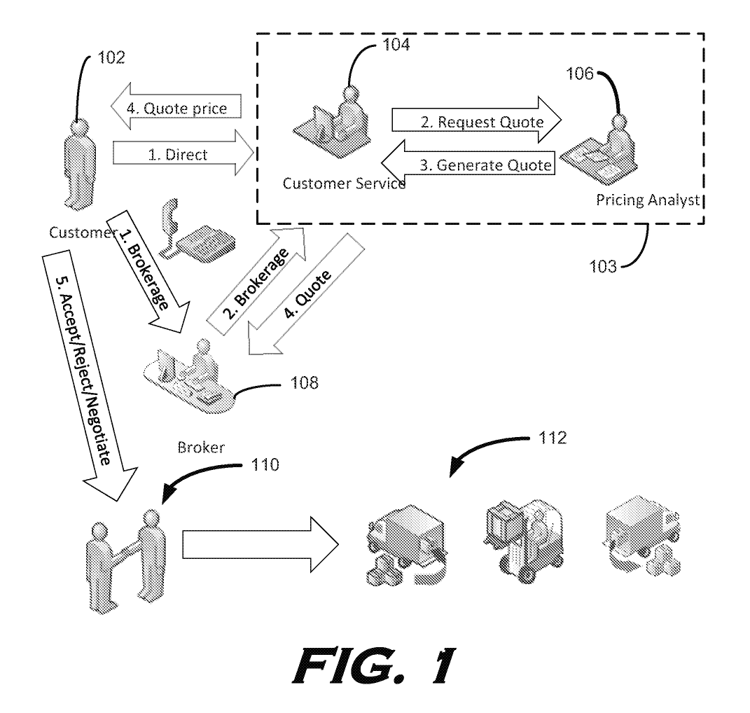

FIG. 1 is an illustration of a typical spot load market shipper/carrier interaction. The illustration of FIG. 1 includes a shipper 102, a carrier 103, and a broker 108. The shipper 102 that has a load to be transported will contact the carrier 103 either directly or indirectly through a broker 108. The shipper 102 will provide load information about the load to be transported, such as origin; destination; weight and size; load specific information such as refrigeration needs and hazmat classifications; time requirements; and other information depending on the load. The shipper 102 communicates the load information to a customer service representative 104 of the carrier 103 or to the broker 108 who then relays the load information to the customer service representative 104 of the carrier 103. The customer service representative 104 requests a price quote from a pricing analyst 106 of the carrier 103 and then relays the price quote to the shipper 102 either directly or via the broker 108. The shipper 102 may then accept, reject, or negotiate further. When the price quote is accepted 110 by the shipper 102, the carrier 103 then proceeds with transporting 112 the load.

Various embodiments illustrated and described herein capture historical data from such transactions between shippers 102 and carriers 103, sometimes with intervening brokers 108, to form a dataset from which demand and price sensitivity models are generated and forecasts may be made. Such forecasts are then utilized by the shipper 103 in view of business rules and goals to facilitate generation of price quotes that are likely to generate shipper 102 price quote acceptances that meet the business rules and goats of the carrier 103, such as maximizing profit margins, growing market share, optimizing vehicle usage to a set threshold value, and the like. The models, forecasts, and price quotes in such a process based in part on historical transactions are typically generated by a computer system that operates to assist the pricing analyst 106 in generating price quotes. In some embodiments, the pricing analyst 106 function may actually be replaced, in whole or in part, by such a system thereby allowing the customer service representative 104 to more rapidly provide price quotes to shippers 102 and brokers 108. Some additional embodiments may facilitate an online system through which a shipper 102 or a broker 108 may input load information and obtain a price quote without interacting with the carrier 103 customer service representative 104. Further, as such a system is utilized in generating price quotes, the load and pricing information may be captured and utilized in keeping the models and forecasts current.

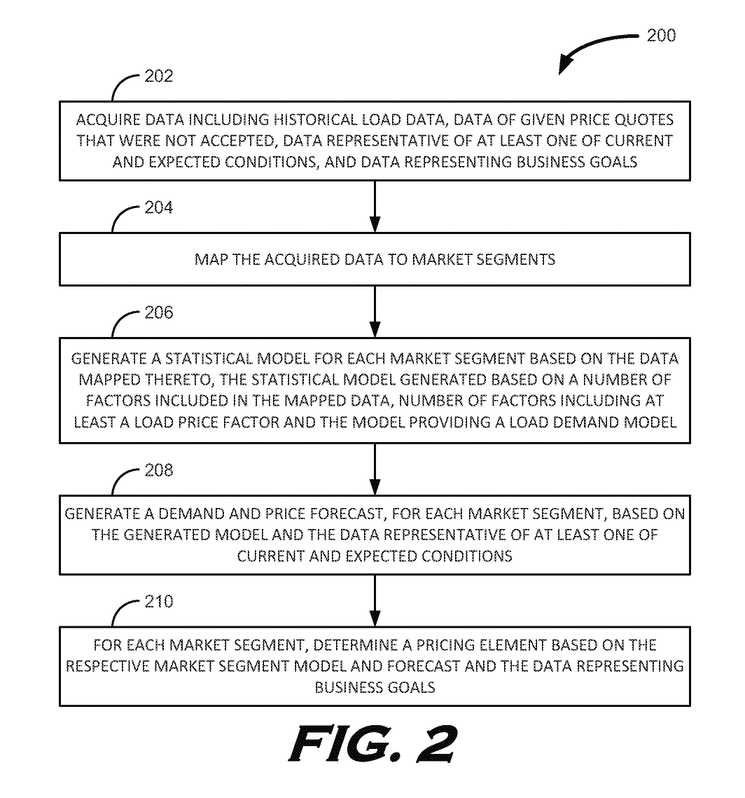

FIG. 2 is block diagram of a method 200 according to an example embodiment. The method 200 is an example of a method performed to build such a model from which forecasts and price quoting may be facilitated. The example method 200 includes acquiring 202 data and mapping 204 the acquired 202 data to market segments.

The acquired 202 data typically includes historical toad data of spot loads hauled by a carrier that operates a computer system implementing the method 200. The load data may identify such things as origin, destination, weight hauled, one or more cargo classifications (e.g., wide load, hazmat, explosive, perishable, etc.), a trailer type (e.g., refrigerated, flatbed, length, etc.), dates of when quotes were made and when the corresponding load was hauled, overall cost, cost per mile (or cost other unit of measure), customer information, and other such data. The acquired 202 data may also include data of quotes provided but not accepted. Such quote data may be retrieved, or received, from data maintained by a quoting system, customer relationship management (CRM) system, or other system that may be a standalone system or a component in a larger system such as an enterprise resource planning (ERP) system The acquired 202 data may also include data representative of historical conditions, which equates to the type of data described immediately below with regard to the data representative of at least of one current and expected conditions. Yet further acquired 202 data may include historical profitability data with regard to hauled spot loads.

The acquired 202 data, in some embodiments, may further include data representative of at least of one current and expected conditions. Data representative of at least of one current and expected conditions may include market indicators such as measures of transportation activity (i.e., Transportation Services Index developed by the Bureau of Transportation Statistics of the United States Government Department of Transportation, Transportation Performance Index as prepared by the United States Chamber of Commerce, or other such index). Other market indicators may include Gross Domestic Product (GDP), unemployment rates, data from financial statements of businesses operating in the transportation markets, interest rates, and other measures related to macro or micro markets, which may be considered relevant to particular embodiments. In some embodiments, the market indicators may, include competitor transportation prices, overall transportation industry or spot load industry market share data, and other competitive data. Some acquired 202 data may be representative of a current or expected condition in only certain market segments or particular geographic regions. For example, if a Hurricane or other major weather event is expected in a certain area for a particular period, such data may be acquired 202, such as through human input or retrieval from a weather database. The acquired 202 data representative of a current or expected condition may be based on measured data or may be based on at least one assumption with regard to an expected condition, such as personnel availability in view of a holiday or an assumption of one or more market conditions. The data representative of a current or expected condition may also be with regard to spot load capacity factors such as vehicle and driver availability for spot loads in view of other spot load non-spot load commitments, vacations, vehicle maintenance, and other factors affecting vehicle and driver availability for spot loads.

In some embodiments, the acquired 202 data may also include data representing business goals. Such business goals may be business rules that define parameters for valid data, relations between data, and other data constraints. Such business goals may also, or alternatively, include goals such as market share targets or trajectories (i.e., growth), profit margin targets such as minimums and maximums, and resource utilization targets such as a maximum utilization percentage for each of one or more resource types (tractors, trailers, employees, etc.). The data representing business goals, in some embodiments, include key performance indicators (KPIs) that may be transportation industry specific, related to best practices without regard to industry, custom KPIs, default software application KPIs, and other KPIs depending on the particular embodiment.

As mentioned above, once such data is acquired 202, the data is then mapped 204 to market segments. Market segments are defined micro-markets within a larger macro-market. For example, the macro-market may be the United States and the micro-markets for which markets are defined may be the Northeast, Southeast, South, Upper-Midwest, Lower Midwest, Southwest, and Northwest. The micro-markets for which market segments are defined may alternatively be individual states, portions of states, or other geographic region. In some embodiments, market segments may also, or alternatively, be defined by industry or cargo types for which transportation services are provided, such as perishable goods, refrigerated goods, dry van shipped good, petroleum, hazmat, flatbed, automobile, and other industries and cargo types. Market segments are therefore sub-portions of all types of transportation services that may be provided by a carrier.

The market segments may be defined by user input, default segments as defined within a software package that executes the method 200 or other software package integrated therewith, or may, in some embodiments, be discovered by a process that executes to identify market segments having unique pricing or profitability characteristics utilizing a form of statistical modeling.

Defined market segments have defining characteristics, such as geographic boundaries of one or both of load origins and destinations. Such characteristics may also be based on distances load are to be transported, an industry for which the load is to be transported, a types of cargo to be hauled, and other characteristics represented in load data. The acquired 202 data is therefore mapped 204 to the appropriate market segments based on the characteristics of the load data and the characteristic definitions of the market segments.

In some embodiments, once the load data is mapped 204 to the market segments, market segments may be evaluated to determine if there is enough data mapped 204 to the respective segments to have statistical significance to model demand and pricing sensitivity for forecasted demand and pricing determinations to be reliable. For example, a market segment having 1,000 elements of data mapped 204 thereto is more likely to be statistically significant than a market segment having only five elements of data mapped 204 thereto, in such instances where a market segment does not have a statistically significant amount of data mapped 204 thereto, a clustering analysis is performed in such embodiments to augment the amount of mapped 204 data. The clustering analysis may capture data mapped 204 to adjoining market segments, acquire 202 additional data from a broader period with regard to the market segment, or otherwise modify the data within the data deficient market segment to provide greater statistical significance to the particular market segment.

Next, the method 200 includes generating 206 a statistical model for each market segment based on the data mapped 204 thereto. The statistical model for each market segment is generated 206 based on a number of factors included in the mapped 204 data. The factors typically include at least a load price factor and factors representative of demand in some form, such as a number of quotes requested over particular periods. The statistical model may model a number of data points, but the model will at least provide a spot load demand model.

The statistical model may be generated 206 according to one of many statistical modeling methods. Such statistical modeling methods may include a regression method, time series modeling, logistic regression, a neural network, a Markov Chain, a Gaussian method, a LOG-liner method, and the like. For example, the generated 206 statistical model may be a Log-linear model that models demand G as a time t dependent variable for a number k of factors x based on the formula:

$$G ( t ) = Exp ( {\sum }_{k} {β}_{k} {x}_{k} ( t ) ) .$$

The method 200 may then generate 208 a demand and price forecast for a period, such as a next day, next week, next two to three weeks, next month, or other period. The method 200 typically generates 208 such a forecast for each market segment and the models are generated 208 based on the generated 206 model and the data representative of at least one of current and expected conditions.

Finally, the method 200, for each market segment, may determine 210 a pricing element based on the respective market segment model and forecast and the data representing business goals. The pricing element may be in the form of a cost per mile, a total mileage price, or a total cost to haul a particular load for which a spot load or other load-pricing request is received. The pricing element, various embodiments, may be only one price factor in a total cost to handle a particular load. For example, the pricing element may only be the transportation cost and additional costs, such as road tolls, fuel surcharge, driver per diem, loading and unloading charges, broker fees, and other charges may be added thereto to form a total price to be included in a price quote.

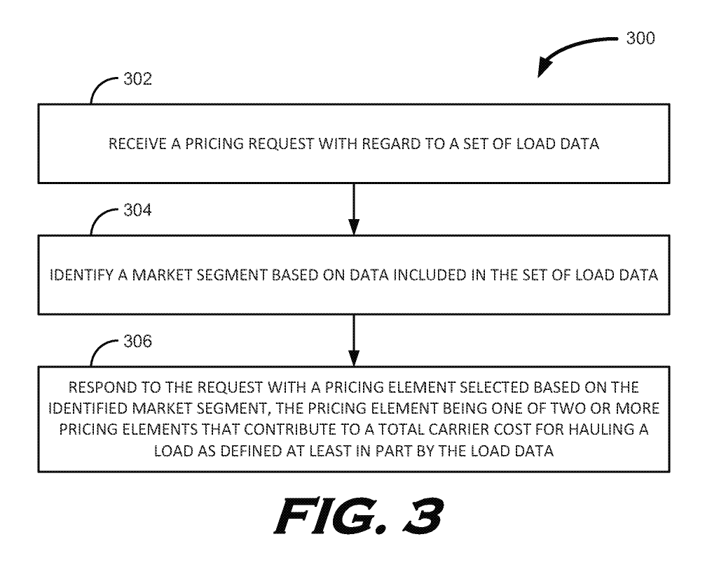

FIG. 3 is block diagram of a method 300 according to an example embodiment. The method 300 is an example of a method of responding to a request for a price quote utilizing a pricing model, such as determined 210 according to the method 200. Thus, subsequent to determining 210 the pricing element for each market segment, a pricing request may be received 302 with regard to a set of load data. The set of load data is then utilized to identify 304 a market segment. Based on the identified 304 market segment, a response 306 is provided to the request with an appropriate pricing element. The pricing element provided in the response 306 is typically one of two or more pricing elements that contribute to a total carrier cost for hauling a load as defined at least in part in the load received 302 with the pricing request. For example, the pricing element may only be the transportation cost and additional costs, such as road tolls, fuel surcharge, driver per diem, loading and unloading charges, broker fees, and other charges may be added thereto to form a total price to be included in a price quote.

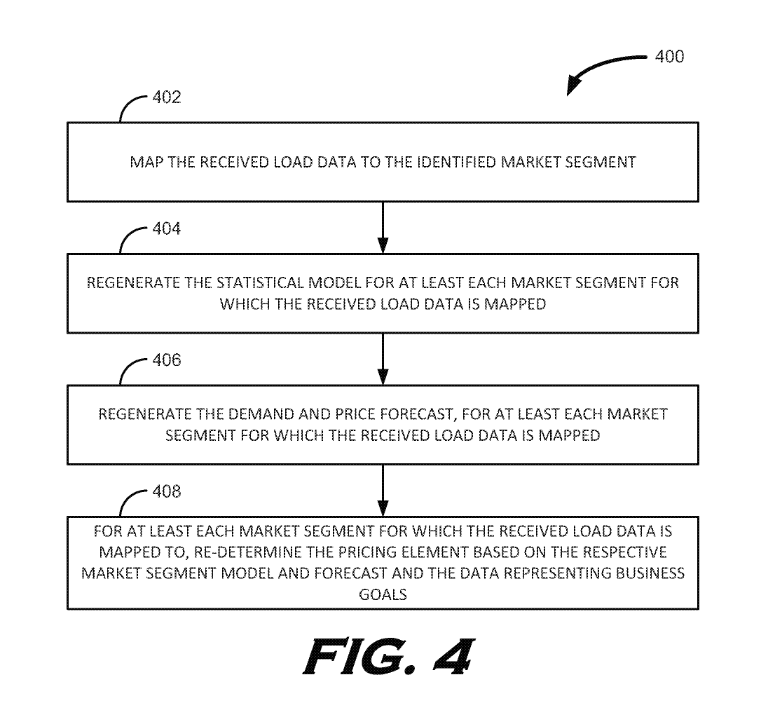

FIG. 4 is block diagram of a method 400 according to an example embodiment. The method 400 is an example method of updating the statistical model, the demand and price forecast, and market segment pricing elements generated 206, 208 and determined 210 in the method 200 of FIG. 2. The method 400 includes mapping 402 load data received since the method 200 was last performed to appropriate market segments. Such load data received since the method 200 was last performed typically includes load data received in pricing requests, such as the pricing request received 302 in the method 300 of FIG. 3. The method 400 may then regenerate 404 the statistical model for at least each market segment for which newly received load data is mapped 402. Next, the method 400 regenerate 406 the demand and price forecast for at least each market segment for which the newly received load data is mapped. The method 400 may then, for at least each market segment for which newly received load data is mapped, re-determine 408 the pricing element based on the respective market segment model and forecast and the data representing business goals.

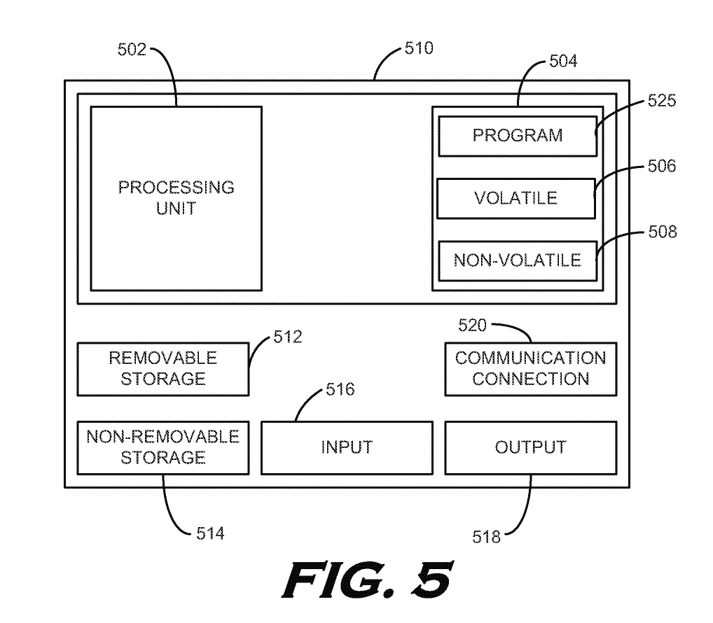

FIG. 5 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 510, may include a processing unit 502, memory 504, removable storage 512, and non-removable storage 514. Memory 504 may include volatile memory 506 and non-volatile memory 508. Computer 510 may include—or have access to a computing environment that includes—a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. These various memories and storages are examples of non-transitory computer-readable mediums and computer-readable storage mediums.

Computer 510 may include or have access to a computing environment that includes input 516, output 518, and a communication connection 520. The computer may operate in a networked environment using a communication connection to connect to one or more remote computers, such as database servers. The remote computer may include a personal computer (PC), server, router, network PC, a peer device or other common network node, or the like. The communication connection may include one or more of a Local Area Network (LAN), a Wide Area Network (WAN), the Internet, a wireless telephone network, or other networks.

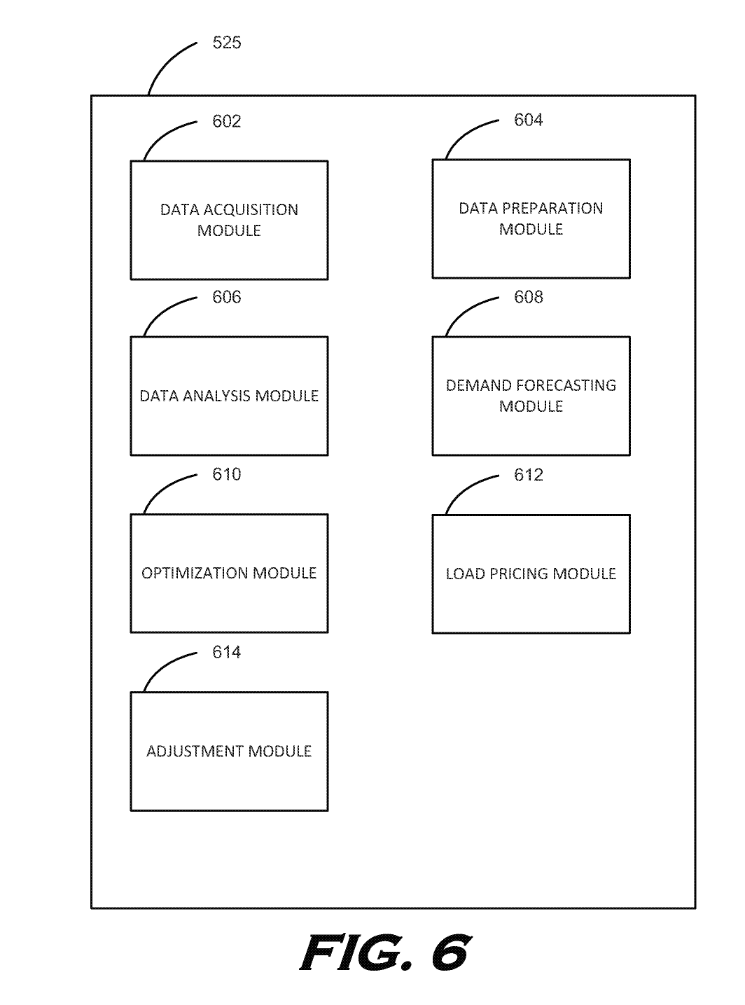

Computer-readable instructions stored on a computer-readable medium are executable by the processing unit 502 of the computer 510. A hard drive, CD-ROM, and RAM are some examples of articles including a computer-readable medium. For example, a computer program 525 capable of performing one or more the methods illustrated and described herein may be stored on such as computer-readable medium. An example of the computer program 525 is illustrated in FIG. 6.

The computer-readable medium may also be referred to as a non-transitory computer readable medium. A non-transitory computer-readable medium is not intended to represent a stationary computer-readable medium that is a fixture and not capable of transport. Instead, a non-transitory computer-readable medium is intended to reflect a physical data storage medium or device that may be transported but is not itself data that is transmitted over a data network, although the data stored on a non-transitory computer readable medium could be read therefrom and transmitted over a network.

FIG. 6 is a block diagram of a computer program 525, according to an example embodiment. The computer program 525 is an example of a computer program 525 as illustrated and described with regard to FIG. 5. The computer program 525 is typically stored in at least one memory device and executable by at least one processor of at least one computing device. The computer program 525 includes a data acquisition module 602, a data preparation module 604, a data analysis module 606, a demand forecasting module 608, and an optimization module 610. In some embodiments, the computer program 525 may also include one or both of a load pricing module 612 and an adjustment module 614.

The data acquisition module 602 is executable by the at least one processor to acquire data including at least historical load data, data of given price quotes that were not accepted, data representative of at least one of current and expected conditions, and data representing business goals, among other data in some embodiment. The data preparation module 604 is executable by the at least one processor to map the acquired data to market segments. The data preparation module 604 may be further executable to identify market segments with too little data mapped thereto for the data to provide statistical significance to the respective market segments. In such embodiments, the data preparation module 604 may then perform a clustering analysis with regard to the identified market segments to bring additional data within the particular market segments to render the data of the market segments statistically significant.

The data analysis module 606 is executable to generate a statistical model for each market segment based on the data mapped thereto. A statistical model is typically generated based on a number of factors included in the mapped data such as a load price factor. Such a model generally provides a spot load demand model. The demand forecasting module 608 executes to generate a demand and price forecast for each market segment by consuming the spot load demand model generated by the data analysis module 606 and the data representative of at least one of current and expected market conditions. The optimization module 610 operates to determine, for each market segment, a pricing element based on the respective market segment model and forecast and the data representing business goals, which may include business rules, KPIs, and objectives of an entity utilizing the computer program 525. The determined pricing element is determined to be an optimal value based on the respective market segment model and forecast and the data representing business goals, which may include business rules, KPIs, and objectives of an entity utilizing the computer program 525.

The load pricing module 612, when included in an embodiment, is executable by the at least one processor to receive pricing requests with regard to a set of load data. The pricing requests are typically received over a network on a network interface device and the pricing request is eventually routed to the load pricing module 612. The toad pricing module 612 then operates to identify a market segment based on data included in the set of load data. The load pricing module 612 will then respond to the request, by communicating data over a network via network interface device. The data communicated via the network interface device includes a pricing element selected based on the identified market segment. The load pricing module 612 may further store the received set of load data for further processing by the other modules 602, 604, 606, 608, 610, 614 to update the various models, pricing forecasts, and pricing elements.

The adjustment module 614 of the computer program 625 operates to update the statistical model, the demand and price forecast, and the pricing element. For example, upon receipt of data not accounted for in the statistical model, the demand and price forecast, and the pricing element, such as data received by the load pricing module 612, in some embodiments, the adjust module may serially call one or more of the data preparing module 604, data analysis module 606, demand forecasting module 608, and optimization module 610 on a periodic basis. The period of the periodic basis may be based on a number of load pricing requests received by the load pricing module 612, passage of a period, such as a number of minutes, hours, days, or weeks, or other interval. In some embodiments, the adjustment module may also, or alternatively, be executed upon receipt of an execution command from a user.

it will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A computerized method comprising:
acquiring data including historical load data, data of given price quotes that were not accepted, data representative of at least one of current and expected conditions including data representative of current and forecasted weather conditions, and data representing business goals;
mapping, by executing instructions on at least one processor, the acquired data to market segments;
generating, by executing instructions on the at least one processor, a statistical model for each market segment based on the data mapped thereto, the statistical model generated based on a number of factors included in the mapped data, number of factors including at least a load price factor and the data representative of current and forecasted weather conditions, the model providing a spot load demand model;
generating, by executing instructions on the at least one processor, a demand and price forecast, for each market segment, based on the generated model and the data representative of at least one of current and expected conditions; and
for each market segment, determining, by executing instructions on the at least one processor, a pricing element based on the respective market segment model and forecast and the data representing business goals.

2. The method of claim 1, wherein the data representing business goals includes data representing at least one of business rules and key performance indicators.

3. The method of claim 1, wherein retrieving data sets from at least one database into the memory includes retrieving data representative of historical and current market conditions.

4. The method of claim 1, further comprising:
identifying a market segment with too little data mapped thereto for the data to provide statistical significance to the market segment; and
performing a clustering analysis with regard to the identified market segment.

5. The method of claim 1, wherein the statistical model is a Log-linear model that models demand G as a time t dependent variable for a number k of factors x based on the formula:
$$G ( t ) = Exp ( {\sum }_{k} {β}_{k} {x}_{k} ( t ) ) .$$

6. The method of claim 1, wherein data representative of the at least one of current and expected conditions includes data representative of at least one assumption with regard to an expected condition and load capacity factors.

7. The method of claim 1, further comprising:
receiving a pricing request with regard to a set of load data;
identifying a market segment based on data included in the set of load data; and
responding to the request with a pricing element selected based on the identified market segment.

8. A non-transitory computer-readable storage medium, with instructions stored thereon which when executed by at least one processor causes a computer to;
acquire data including historical load data, data of given price quotes that were not accepted, data representative of at least one of current and expected conditions including data representative of current and forecasted weather conditions, and data representing business goals;
map the acquired data to market segments;
generate a statistical model for each market segment based on the data mapped thereto, the statistical model generated based on a number of factors included in the mapped data, number of factors including at least a load price factor and the data representative of current and forecasted weather conditions, the model providing a spot load demand model;
generate a demand and price forecast, for each market segment, based on the generated model and the data representative of at least one of current and expected conditions; and
for each market segment, determine a pricing element based on the respective market segment model and forecast and the data representing business goals.

9. The non-transitory computer-readable storage medium of claim 8, wherein the data representing business goals includes data representing at least one of business rules and key performance indicators.

10. The non-transitory computer-readable storage medium of claim 8, with further instructions stored thereon which when executed by the at least one computer processor further cause the computer to:
identify a market segment with too little data mapped thereto for the data to provide statistical significance to the market segment; and
perform a clustering analysis with regard to the identified market segment.

11. The non-transitory computer-readable storage medium of claim 8, wherein the statistical model is a regression model.

12. The non-transitory computer-readable storage medium of claim 8, wherein data representative of the at least one of current and expected conditions includes data representative of at least one assumption with regard to an expected condition and load capacity factors.

13. The non-transitory computer-readable storage medium of claim 8, with further instructions stored thereon which when executed by the at least one computer processor further cause the computer to:
receive a pricing request with regard to a set of load data;
identify a market segment based on data included in the set of load data; and
respond to the request with a pricing element selected based on the identified market segment, the pricing element being one of two or more pricing elements that contribute to a total carrier cost for hauling a load as defined at least in part by the load data.

14. The non-transitory computer-readable storage medium of claim 13, with further instructions stored thereon which when executed by the at least one computer processor further cause the computer to:
map the received load data to the identified market segment;
regenerate the statistical model for at least each market segment for which the received load data is mapped;
regenerate the demand and price forecast, for at least each market segment for which the received load data is mapped; and
for at least each market segment for which the received load data is mapped, re-determine the pricing element based on the respective market segment model and forecast and the data representing business goals.

15. A system comprising:
at least one computing device including at least one processor and at least one memory device;
a data acquisition module stored in the at least one memory device and executable by the at least one processor to acquire data including historical load data, data of given price quotes that were not accepted, data representative of at least one of current and expected conditions including data representative of current and forecasted weather conditions, and data representing business goals;
a data preparation module stored in the at least one memory device and executable by the at least one processor to map the acquired data to market segments;
a data analysis module stored in the at least one memory device and executable by the at least one processor to generate a statistical model for each market segment based on the data mapped thereto, the statistical model generated based on a number of factors included in the mapped data, number of factors including at least a load price factor and the data representative of current and forecasted weather conditions, the model providing a spot load demand model;
a demand forecasting module stored in the at least one memory device and executable by the at least one processor to generate a demand and price forecast, for each market segment, based on the generated model and the data representative of at least one of current and expected conditions; and
an optimization module stored in the at least one memory device and executable by the at least one processor to determine, for each market segment, a pricing element based on the respective market segment model and forecast and the data representing business goals.

16. The system of claim 15, wherein the data preparation module is further executable by the at least one processor to:
identify a market segment with too little data mapped thereto for the data to provide statistical significance to the market segment; and
perform a clustering analysis with regard to the identified market segment.

17. The system of claim 15, wherein the statistical model generated by the data analysis module is a Gaussian model.

18. The system of claim 15, wherein data representative of the at least one of current and expected conditions acquired by the data acquisition module includes data representative of at least one assumption with regard to an expected condition and load capacity factors.

19. The system of claim 15, further comprising:
at least one network interface device; and
a load pricing module stored in the at least one memory device and executable by the at least one processor to:
receive, via the at least one network interface device, a pricing request with regard to a set of load data;
identify a market segment based on data included in the set of load data; and
respond to the request, via the at least one network interface device, with a pricing element selected based on the identified market segment, the pricing element being one of two or more pricing elements that contribute to a total carrier cost for hauling a load as defined at least in part by the load data.

20. The system of claim 15, further comprising:
an adjustment module stored in the at least one memory device and executable by the at least one processor to:
call the mapping module to map the received load data to the identified market segment;
call the data analysis module to regenerate the statistical model for at least each market segment for which the received load data is mapped;
call the demand forecasting module to regenerate the demand and price forecast, for at least each market segment for which the received load data is mapped; and
call the optimization module to re-determine the pricing element, for at least each market segment for which the received load data is mapped, based on the respective market segment model and forecast and the data representing business goals.
